(19) United States
(12) Patent Application Publication
(10) Pub. No.: US 2018/0030766 A1
(43) Pub. Date: Feb. 1, 2018

(54) DOOR HINGE ASSEMBLY

(71) Applicant: VOLVO CONSTRUCTION EQUIPMENT AB, Eskilstuna (SE)

(72) Inventors: Hyun Woo YEOM, Nam-gu Daegu (KR); Seok Won KIM, Nam-gu Busan (KR)

(73) Assignee: VOLVO CONSTRUCTION EQUIPMENT AB, Eskilstuna (SE)

(21) Appl. No.: 15/549,150

(22) PCT Filed: Feb. 10, 2015
(86) PCT No.: PCT/KR2015/001302

§ 371 Date: Aug. 5, 2017

(51) Int. Cl. E05D 7/086; E05F 3/22; E05F 3/20

(52) U.S. Cl. CPC E05D 7/086; E05F 3/20; E05F 3/22

(57) ABSTRACT

A door hinge assembly is provided which can prevent the phenomenon of closure of an open door by performing a self-stay function, and can improve a worker's or user's convenience and implement a cost saving effect by simplifying the configuration compared to the prior art in which a hinge and a stay are separately provided. To this end, the door hinge assembly includes a hinge shaft, a rotary plate which has one side rotatably connected to the hinge shaft and has the other side connected to a door, and a fixing plate which has one side connected to the hinge shaft and has the other side fixed to a door frame which is formed on the wall surface of an inner space that is opened and closed by the door, wherein the upper end surface of the rotary plate is divided into a reference surface and a stepped surface which has a relatively lower height than the reference surface, and a protrusion part which can be mounted on the reference surface is formed on the outer circumferential surface of the hinge shaft which faces the upper end surface of the rotary plate.

### BACKGROUND AND SUMMARY

The present disclosure relates to a door hinge assembly. More particularly, the present disclosure relates to a door hinge assembly that can also function as a stay to prevent an opened door from being closed and has a simplified configuration, compared to conventional door hinge assemblies in which a hinge and a stay are provided separately, to improve convenience of an operator or a user and reduce costs.

In general, a door hinge is a component used in a hinged door which pivots about a shaft to be opened or closed. Door hinges are widely used not only in industrial fields, such as in construction machines, but also in offices and houses, encountered during daily life.

A door hinge used in a construction machine, such as an excavator, functions to support a side door of the excavator to pivotally connect the side door to a door frame of a cab or an engine compartment such that the side door can be opened and closed. However, a separate door stay device is required to maintain the side door in an opened position. A purpose of the door stay device is to keep the door opened during work such that the operator can easily perform the work and to prevent the side door from being abruptly closed by strong wind, a physical impact, or the like, thereby securing a safe working environment.

However, in the related art, the door stay device and the door hinge are provided separately from each other, and the door stay device is installed in a separate position, thereby imposing restrictions on a space in which the door stay device is disposed. After the side door is opened via the door hinge, the door stay device must be manipulated to maintain the side door in the opened position. Thus, the problem of rather complicated manipulation is caused. In addition, the door stay device disposed separately from the door hinge causes a number of problems, such as difficulty in maintenance and increased costs for installation of the side door.

Accordingly, it is desirable to provide a door hinge assembly that can also function as a stay to prevent an opened door from being closed and has a simplified configuration, compared to conventional door hinge assemblies in which a hinge and a stay are provided separately, to improve convenience of an operator or a user and reduce costs.

According to an aspect of the present disclosure, a door hinge assembly may include: a hinge shaft; a movable leaf including a first portion, pivotably connected to the hinge shaft, and a second portion, connected to a door; and a stationary leaf including a first portion, connected to the hinge shaft, and a second portion, fixed to a door frame provided on a wall of an inner space that is opened and closed by the door. A top surface of the movable leaf has a base surface and a step-down surface, a height of which is lower than a height of the base surface. The hinge shaft has a protrusion on an outer circumferential surface thereof over the top surface of the movable leaf, the protrusion of the hinge shaft being able to be placed on the base surface.

With respect to an opening direction of the door, the base surface may be provided upstream, and the step-down surface may be provided downstream.

A circumferential width of the protrusion may be the same as or narrower than a circumferential width of the step-down surface.

When the door is in a closed position, the protrusion may be placed on the base surface.

When the door is in an opened position, the protrusion may be placed above the step-down surface.

When the door is opened, the base surface may slide under the protrusion while the movable leaf rotates along with the door, and then the protrusion may descend toward the step-down surface by gravity to be located above the step-down surface, in a position lower than the base surface. The top surface of the moveable leaf may further include a vertical surface defined between the base surface and the step-down surface. A rotation of the movable leaf in a closing direction of the door may be blocked by the protrusion located upstream of the vertical surface with respect to the closing direction of the door, so that the door remains in the opened position.

The door hinge assembly may further include a stopper unit disposed between the stationary leaf and the hinge shaft to stop further descent of the protrusion.

The stopper unit may include a step extending from a wall surface of the stationary leaf facing the hinge shaft and a protrusion protruding from an outer circumferential surface of the hinge shaft, the protrusion of the stopper unit allowed to be placed on the step of the stopper unit.

According to the present disclosure, the door hinge assembly can also function as a stay to prevent an opened door from being closed, i.e. maintain the door in an opened position, using to hinge structure to improve convenience and safety of an operator or a user.

In addition, according to the present disclosure, the door hinge assembly has a simplified configuration, compared to conventional door hinge assemblies in which a hinge and a stay are provided separately, to reduce costs and provide freedom from restrictions on a space in which the door hinge assembly can be disposed.

### BRIEF DESCRIPTION OF THE DRAWINGS

FIGS. 1 and 2 illustrate a door hinge assembly according to exemplary embodiments, in which FIG. 1 illustrates the door hinge assembly in an opened position, while FIG. 2 illustrates the door hinge assembly in a closed position;

FIGS. 3 and 4 are enlarged views of area “A” in FIG. 1;

FIGS. 5 and 6 are enlarged views of one and the other sides of area “B” in FIG. 2;

FIG. 7 is an enlarged view of area “C” FIG. 1; and

FIG. 8 is an enlarged view of area “D” in FIG. 2.

### DETAILED DESCRIPTION

Hereinafter, a door hinge assembly according to exemplary embodiments will be described in detail with reference to the accompanying drawings.

In the following disclosure, detailed descriptions of known functions and components incorporated herein will be omitted in the case that the subject matter of the present disclosure may be rendered unclear by the inclusion thereof.

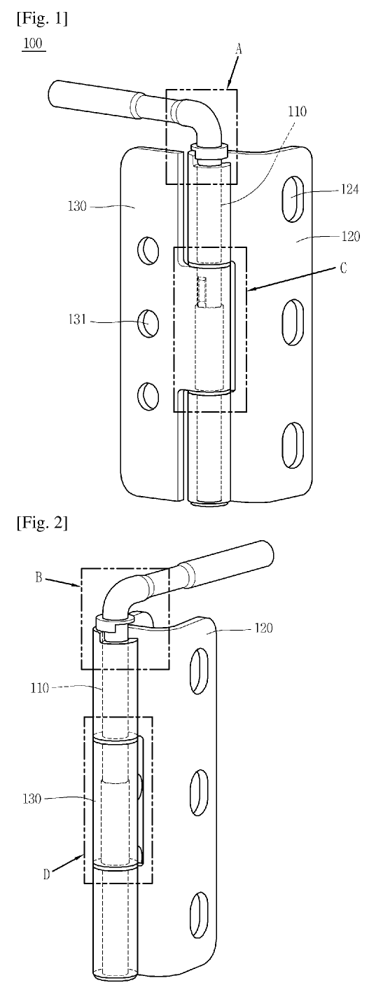

As illustrated in FIGS. 1 and 2, a door hinge assembly 100 according to exemplary embodiments may pivotally connect a side door of a construction machine, for example, an excavator, to a door frame of a cabin or an engine compartment, such that the cabin or the engine compartment can be opened or closed. The door hinge assembly 100 according to an exemplary embodiment functions to maintain the side door in an opened position.

In this regard, the door hinge assembly 100 according to an exemplary embodiment includes a hinge shaft 110, a movable leaf 120, and a stationary leaf 130.

The hinge shaft 110 provides a hinge structure together with the movable leaf 120 connected thereto, such that the movable leaf 120 is rotatable. In this regard, the hinge shaft 110 is rod-shaped, and a tubular portion of the movable leaf 120 is coupled to the hinge shaft 110 while surrounding the hinge shaft 110.

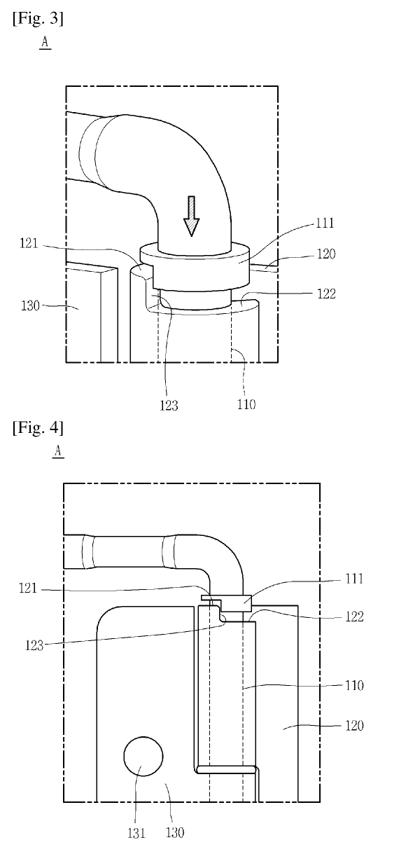

In an exemplary embodiment, the hinge shaft 110, as illustrated in FIG. 3, has a protrusion 111 on a portion thereof adjacent to a top surface of the movable leaf 120. The protrusion 111 protrudes by a distance sufficient to allow the protrusion 111 to be placed on the top surface of the movable leaf 120. In addition, the protrusion 111 is provided to partially surround a circumference of the hinge shaft 110.

In an exemplary embodiment, the protrusion 111 prevents the door from rotating from an opened position to a closed position, according to a change of a position of the top surface of the movable leaf 120, i.e. in practice, according to a change of a position of the top surface of the movable leaf 120 located below the protrusion 111, thereby maintaining the door in the opened position. This feature will be described in greater detail later.

A rotation of the movable leaf 120 allows the door to be opened and closed. In this regard, a first portion of the movable leaf 120 is connected to the hinge shaft 110. As illustrated in the drawings, the first portion of the movable leaf 120 having a tubular shape has an opening in a longitudinally middle portion thereof such that a first portion of the stationary leaf 130 is coupled to the hinge shaft 110 in the opening.

A second portion of the movable leaf 120 is plate-shaped. A plurality of bolt holes 124 may be formed in the second portion of the movable leaf 120, such that the movable leaf 120 can be fixed to the door using bolts screwed into the bolt holes 124. The connection structure of connecting the movable leaf 120 to the door, as described above, allows the door to rotate to open and close the cabin or the engine compartment.

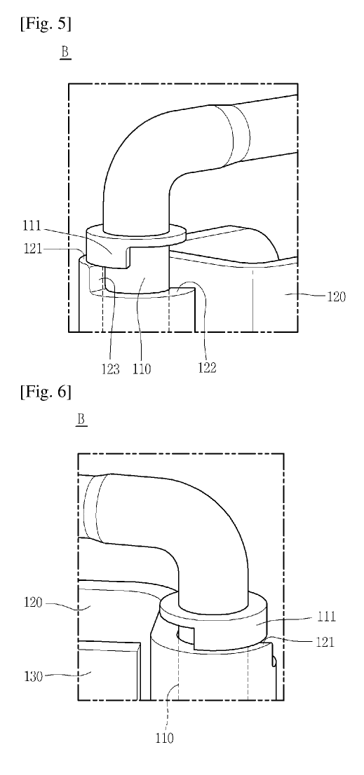

The top surface of the movable leaf 120 has different heights. Specifically, in an exemplary embodiment, the top surface of the movable leaf 120, as illustrated in FIG. 3, includes a base surface 121 and a step-down surface 122, the height of which is lower than that of the base surface 121. With respect to the direction in which the door is opened (hereinafter, referred to as the opening direction of the door), the base surface 121 is located upstream, while the step-down surface 122 is located downstream. Thus, as illustrated in FIGS. 5 and 6, when the door is in a closed position, the protrusion 111 is placed on the base surface 121.

As illustrated in FIGS. 3 and 4, when the door is opened, the movable leaf 120 rotates along with the door in the opening direction of the door, such that the base surface 121, on which the protrusion 111 has been placed, slides along the undersurface of the protrusion 111 in the direction in which the door rotates until the step-down surface 122 is located below the protrusion 111. The circumferential width of the protrusion 111 is determined to be the same as or smaller than the circumferential width of the step-down surface 122. Thus, the protrusion 111 is driven downwardly toward the step-down surface 122 by gravity, to be located above the step-down surface 122 but below the base surface 121. In this case, rotation of the movable leaf 120 in the closing direction of the door is blocked by the protrusion 111 located upstream of a vertical surface 123 defined by the base surface 121 and the step-down surface 122, with respect to the closing direction of the door. Thus, the door remains in the opened position. In other words, according to the exemplary embodiment, the protrusion 111 of the hinge shall 110 and the step-down surface 122 of the movable leaf 120 function as a locking unit to maintain the door in the opened position or prevent the door from being closed. Then, the side door can be prevented from being unintentionally closed by strong force, wind, a physical impact, or the like while the operator is performing work relating to the cabin or die engine compartment, so that a safe working environment can be secured.

The stationary leaf 130 is a member connecting the hinge shaft 110, the movable leaf 120, and the door, which are connected together, to a door frame. In this reward, the tubular first portion of the stationary leaf 130 is connected to the hinge shaft 110. As illustrated in the drawings, the tubular first portion of the stationary leaf 130 is fitted around the outer circumferential surface of the hinge shaft 110 exposed through the opening in the middle portion of the movable leaf 120 when the hinge shaft 110 is fitted into the first portion of the movable leaf 120. However, this is merely illustrative, and the coupling structure comprised of the hinge shaft 110, the movable leaf 120, and the stationary leaf 130 may be provided in a variety of other forms.

A second portion of the stationary leaf 130 is plate-shaped. A plurality of bolt holes 131 may be formed in the second portion of the stationary leaf 130, such that the stationary leaf 130 can be fixed to the door frame provided on the wall of the cabin or the engine compartment, which is opened and closed by the door, using bolts screwed into the bolt holes 131.

As described above, to open the door, the movable leaf 420 is rotated along with the door in the opening direction of the door until the step-down surface 122 is located below the protrusion 111. The height of the step-down surface 122 is lower than the height of the base surface 121 on which the protrusion 111 has been placed. Thus, the protrusion 111 naturally descends above the step-down surface 122, the height of which is lower than that of the base surface 121. If the protrusion 111 is allowed to descend into contact with the step-down surface 122, the protrusion 111 may descend too far. Then, it may be difficult to move the protrusion 111 to be placed on the base surface 121 upwardly, so as to close the opened door.

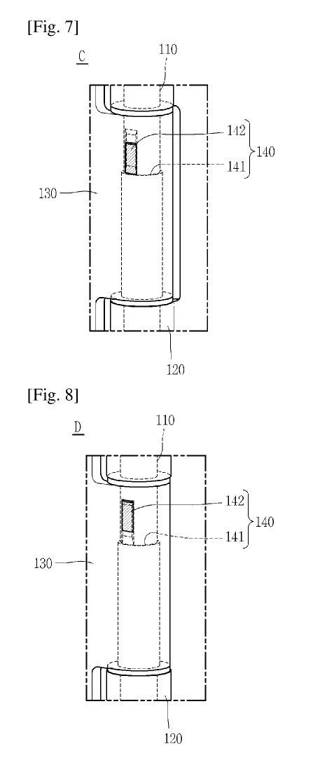

As illustrated in FIGS. 7 and 8, according to an exemplary embodiment, a stopper unit 140 is further provided to deal with this issue. The stopper unit 140 is disposed between the hinge shaft 110 and the stationary leaf 130 to stop further descent of the protrusion 111, i.e. to control a distance by which the protrusion 111 descends.

The stopper unit 140 according to the exemplary embodiment includes a step 141 and a protrusion 142. The step 141 extends from an inner wall surface of the first portion of the stationary leaf 130 facing the hinge shaft 110 in the direction of the hinge shaft 110. The protrusion 142 protrudes from an outer circumferential surface of the hinge shaft 110 in the direction of the stationary leaf 130, such that the protrusion 142 can be caught on the step 141 extending from the stationary leaf 130.

First, FIG. 8 illustrates a coupling structure of the step 141 and the protrusion 142 when the door is in a closed position. Specifically, the protrusion 111, provided on the upper portion of the hinge shaft 110 (in the longitudinal direction), is placed on the base surface 121 of the movable leaf 120. Thus, when the door is in the closed position, the protrusion 142 provided on the central portion of the hinge shaft 110 (in the longitudinal direction) and the step 141 provided on the stationary leaf 130 are not in contact with and are spaced apart from each other. According to an exemplary embodiment, at this time, a distance between the step 141 and the protrusion 142 is smaller than the difference in height between the base surface 121 and the step-down surface 122, or a distance between the protrusion 111 and the step-down surface 122.

Subsequently, FIG. 7 illustrates a coupling structure of the step 141 and the protrusion 142 when the door is in an opened position. As the protrusion 111 descends toward the step-down surface 122, i.e. the hinge shaft 110 having the protrusion 111 descends, the protrusion 142 provided on the hinge shaft 110 descends to come into contact with and be placed on the step 141, the position of which is fixed. When the protrusion 142 is caught on the step 141 as described above, further descent of the protrusion 111 is forcibly stopped. Since a distance between the step 141 and the protrusion 142 is smaller than a distance between the protrusion 111 and the step-down surface 122 when the door is in a closed position, when the protrusion 142 is placed on the step 141 after having descended, the protrusion 111 is located above the step-down surface 122, the height of which is lower than that of the base surface 121, distant from the step-down surface 122. As described above, when the distance by which the protrusion 111 descends is controlled using such a coupling structure in which the step 141 and the protrusion 142 are coupled when the door is in an opened position, it is possible to more easily close the door from the opened position.

As set forth above, the door hinge assembly 100 according to an exemplary embodiment includes a locking unit comprised of the protrusion 111 provided on the hinge shaft 110 and the step-down surface 122 provided on the movable leaf 120, i.e. a structure for maintaining a door in an opened position. The door hinge assembly 100 according to an exemplary embodiment includes the stopper unit 140 including the step 141 and the protrusion 142 to control a distance by which the protrusion 111 descends toward the step-down surface 122. As set forth above, the door fringe assembly 100 according to exemplary embodiments has a simplified configuration, compared to the related art in which a door hinge and a stay are provided separately, and also functions as a stay to maintain an opened door in an opened position. This can consequently improve convenience and safety of an operator or a user, reduce costs, and provide freedom from restrictions on a space in which the door hinge assembly is disposed.

The foregoing descriptions of specific exemplary embodiments of the present disclosure have been presented with respect to the drawings and are not intended to be exhaustive or to limit the present disclosure to the precise forms disclosed, and obviously many modifications and variations are possible for a person having ordinary skill in the art in light of the above teachings.

It is intended therefore that the scope of the present disclosure not be limited to the foregoing embodiments, but be defined by the Claims appended hereto and their equivalents.

1. A door hinge assembly comprising:
a hinge shaft;
a movable leaf comprising a first portion, pivotably connected to the hinge shaft, and a second portion, connected to a door; and
a stationary leaf comprising a first portion, connected to the hinge shaft, and a second portion, fixed to a door frame provided on a wall of an inner space that is opened and closed by the door,
wherein a top surface of the movable leaf comprises a base surface and a step-down surface, a height of which is lower than a height of the base surface, and
the hinge shaft comprises a protrusion on an outer circumferential surface thereof over the top surface of the movable leaf, the protrusion of the hinge shaft being able to be placed on the base surface.

2. The door hinge assembly of claim 1, wherein, with respect to an opening direction of the door, the base surface is provided upstream, and the step-down surface is provided downstream.

3. The door hinge assembly of claim 1, wherein a circumferential width of the protrusion is the same as or narrower than a circumferential width of the step-down surface.

4. The door hinge assembly of claim 1, wherein, when the door is in a closed position, the protrusion is placed on the base surface.

5. The door hinge assembly of claim 1, wherein, when the door is in an opened position, the protrusion is placed above the step-down surface.

6. The door hinge assembly of claim 5, wherein,
when the door is opened, the base surface slides under the protrusion while the movable leaf rotates along with the door, and then the protrusion descends toward the step-down surface by gravity to be located above the step-down surface, in a position lower than the base surface,
the top surface of the movable leaf further comprises a vertical surface defined between the base surface and the step-down surface, and
a rotation of the movable leaf in a closing direction of the door is blocked by the protrusion located upstream of the vertical surface with respect to the closing direction of the door, so that the door remains in the opened position.

7. The door hinge assembly of claim 6, further comprising a stopper unit disposed between the stationary leaf and the hinge shaft to stop further descent of the protrusion.

8. The door hinge assembly of claim 7, wherein the stopper unit comprises a step extending from a wall surface of the stationary leaf facing the hinge shaft and a protrusion protruding from an outer circumferential surface of the hinge shaft, the protrusion of the stopper unit allowed to be placed on the step of the stopper unit.
